(19) United States
(12) Patent Application Publication
(10) Pub. No.: US 2024/0163658 A1
(43) Pub. Date: May 16, 2024

(54) METHOD AND DEVICE FOR CAPABILITY ACQUISITION AND METHOD AND DEVICE FOR CAPABILITY REPORTING

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/548,774

(22) PCT Filed: Mar. 5, 2021
(86) PCT No.: PCT/CN2021/079305

§ 371 Date: Sep. 1, 2023

(51) Int. Cl. H04W 8/22; H04B 7/06; H04W 16/28

(52) U.S. Cl. CPC H04W 8/22; H04B 7/0617; H04B 7/063; H04W 16/28

(57) ABSTRACT

A method for capability acquisition includes obtaining, by a base station, capability information of a terminal. The capability information is used for indicating whether the terminal has multi-panel beam collaborative management capability, and the multi-panel beam collaborative management capability refers to the terminal being capable of determining an alternate second panel in response to a first panel being used for communication with the base station.

### CROSS-REFERENCE TO RELATED APPLICATIONS

The present application is a U.S. National Stage of International Application No. PCT/CN2021/079305, filed on Mar. 5, 2021, the disclosure of which is incorporated herein by reference in its entirety for all purposes.

### BACKGROUND

### Technical Field

When a terminal communicates with a base station, in order to ensure that the terminal is capable of receiving signals when it is located at different angles of the base station, a plurality of antenna panels may be provided in the terminal, and each of the panels may be capable of communicating on a plurality of beams so as to cover a certain angle range.

### SUMMARY

The present disclosure relates to the field of communication technology, and specifically to a method for capability acquisition, a method for capability reporting, a device for capability acquisition, a device for capability reporting, a communication device, and a computer-readable storage medium.

According to a first aspect of the embodiments of the present disclosure, a method for capability acquisition is proposed. The method for capability acquisition is applied to a base station, and includes: obtaining capability information of a terminal.

The capability information is used for indicating whether the terminal has multi-panel beam collaborative management capability, and the multi-panel beam collaborative management capability refers to the terminal being capable of determining an alternate second panel when a first panel is used for communication with the base station.

According to a second aspect of the embodiments of the present disclosure, a method for capability reporting is proposed. The method for capability reporting is applied to a terminal, and includes: sending capability information to a base station.

The capability information is used for indicating whether the terminal has multi-panel beam collaborative management capability, and the multi-panel beam collaborative management capability refers to the terminal being capable of determining an alternate second panel when a first panel is used for communication with the base station.

According to a third aspect of the embodiments of the present disclosure, a communication device is proposed. The communication device includes a processor and a memory that is configured to store an instruction executable by the processor. The processor is configured to perform the method for capability acquisition, and/or the method for capability reporting described above.

According to a fourth aspect of the embodiments of the present disclosure, a computer-readable storage medium is proposed. The non-transitory computer-readable storage medium is configured to store a computer program, and the computer program, when executed by a processor, implements steps of the method for capability acquisition and/or steps of the method for capability reporting.

### BRIEF DESCRIPTION OF THE DRAWINGS

In order to more clearly illustrate the technical solutions in the embodiments of the present disclosure, the accompanying drawings that need to be used in the description of the embodiments will be briefly introduced below, and it is apparent that the accompanying drawings in the following description are only some of the embodiments of the present disclosure, and that for those ordinary skilled in the art, other accompanying drawings may be obtained based on these drawings without exerting creative labor.

FIG. 1 is a schematic flowchart of a method for capability acquisition illustrated according to an embodiment of the present disclosure.

FIG. 2 is a schematic flowchart of another method for capability acquisition illustrated according to an embodiment of the present disclosure.

FIG. 3 is a schematic flowchart of yet another method for capability acquisition illustrated according to an embodiment of the present disclosure.

FIG. 4 is a schematic flowchart of yet another method for capability acquisition illustrated according to an embodiment of the present disclosure.

FIG. 5 is a schematic flowchart of yet another method for capability acquisition illustrated according to an embodiment of the present disclosure.

FIG. 6 is a schematic flowchart of yet another method for capability acquisition illustrated according to an embodiment of the present disclosure.

FIG. 7 is a schematic flowchart of yet another method for capability acquisition illustrated according to an embodiment of the present disclosure.

FIG. 8 is a schematic flowchart of a method for capability reporting illustrated according to an embodiment of the present disclosure.

FIG. 9 is a schematic flowchart of another method for capability reporting illustrated according to an embodiment of the present disclosure.

FIG. 10 is a schematic flowchart of yet another method for capability reporting illustrated according to an embodiment of the present disclosure.

FIG. 11 is a schematic flowchart of yet another method for capability reporting illustrated according to an embodiment of the present disclosure.

FIG. 12 is a schematic flowchart of yet another method for capability reporting illustrated according to an embodiment of the present disclosure.

FIG. 13 is a schematic diagram of determining a second beam illustrated according to an embodiment of the present disclosure.

FIG. 14 is a schematic flowchart of yet another method for capability reporting illustrated according to an embodiment of the present disclosure.

FIG. 15 is a schematic flow diagram of yet another method for capability reporting illustrated according to an embodiment of the present disclosure.

FIG. 16 is a schematic block diagram of a device for capability acquisition illustrated according to an embodiment of the present disclosure.

FIG. 17 is a schematic block diagram of another device for capability acquisition illustrated according to an embodiment of the present disclosure.

FIG. 18 is a schematic block diagram of yet another device for capability acquisition illustrated according to an embodiment of the present disclosure.

FIG. 19 is a schematic block diagram of a device for capability reporting illustrated according to an embodiment of the present disclosure.

FIG. 20 is a schematic block diagram of another device for capability reporting illustrated according to an embodiment of the present disclosure.

FIG. 21 is a schematic block diagram of yet another device for capability reporting illustrated according to an embodiment of the present disclosure.

FIG. 22 is a schematic block diagram of device for capability acquisition illustrated according to an embodiment of the present disclosure.

FIG. 23 is a schematic block diagram of device for capability reporting illustrated according to an embodiment of the present disclosure.

### DETAILED DESCRIPTION OF THE PREFERRED EMBODIMENTS

The technical solutions in the embodiments of the present disclosure will be described clearly and completely in the following in conjunction with the accompanying drawings in the embodiments of the present disclosure, and it is apparent that the described embodiments are only a part of the embodiments of the present disclosure, but not all of the embodiments. All other embodiments obtained by those ordinary skilled in the art based on the embodiments in the present disclosure without making creative labor fall within the scope of protection of the present disclosure.

In case a communication quality of a currently used panel is poor, the terminal may enable other panels for communication in order to ensure the communication quality. However, since there are a plurality of panels provided in the terminal and different panels are independent of each other, in order to determine an suitable panel among the plurality of panels, it is necessary to perform beam scanning by using each of the panels respectively to determine the panel whose communication quality satisfies the requirements. However, determining communication qualities for all the panels consumes more power and has a larger time delay. In view of this, embodiments of the present disclosure propose a method for capability acquisition, a method for capability reporting, a device for capability acquisition, a device for capability reporting, a communication device, and a computer-readable storage medium to solve technical problems in related arts. FIG. 1 is a schematic flowchart of a method for capability acquisition illustrated according to an embodiment of the present disclosure. The method for capability acquisition shown in this embodiment may be applied to a base station, and the base station includes but is not limited to a base station in a communication system such as a 4G base station, a 5G base station, a 6G base station, and the like. The base station may communicate with a terminal which is used as a user device, for example, the base station may communicate in a millimeter wave frequency band or in a terahertz frequency band, and the terminal includes but is not limited to a communication device such as a cellular phone, a tablet computer, a wearable device, a sensor, an internet of thing (IOT) device, and the like.

In an embodiment, the terminal may be a terminal that the method for capability reporting described in any subsequent embodiment is applicable to.

In an embodiment, a plurality of panels may be provided in the terminal, and different panels may be provided at different positions in the terminal. The panel refers to the antenna panel in the terminal, and the terminal may perform communication by using the antenna panel. The panel may communicate on a plurality of beams, and directions of each of the beams may be different.

The following is mainly described in the case of the plurality of panels including the first panel and the second panel. The first panel and the second panel do not specifically refer to particular panels in the terminal, but mainly refers to any two different panels in the terminal.

As shown in FIG. 1, the method for capability acquisition may include the following step S101.

At step S101, capability information of a terminal is obtained. In this embodiment, the capability information is used for indicating whether the terminal has multi-panel beam collaborative management capability, and the multi-panel beam collaborative management capability refers to the terminal being capable of determining an alternate second panel when a first panel is used for communication with the base station.

In an embodiment, the terminal may report the capability information, for example, the terminal may directly report the capability information to the base station, or the terminal may report the capability information to a core network, which then sends the capability information to the base station. For example, the terminal may report the capability information to the base station by carrying the capability information in a newly added signaling, or the terminal may report the capability information to the base station by expanding an existing signaling to carry the capability information, such as reporting the capability information to the base station by carrying the capability information in a codebookParameters signaling.

In an embodiment, if the terminal is capable of determining the alternate second panel when the first panel is used for communication with the base station, the terminal may be shown to have the multi-panel beam collaborative management capability through the capability information.

In an embodiment, in the case of the terminal having the capability, when the terminal communicates with the base station by using the first panel, the terminal is able to predict, among the panels other than the first panel, the panel through which the communication quality of communication with the base station satisfies the requirements as the second panel, so that when the communication quality of communication performed by using the first panel does not satisfy the requirements, the terminal may enable, based on an indication of the base station (or automatically), the second panel to communicate with the base station to ensure the communication quality.

According to the embodiments of the present disclosure, the base station may determine, by obtaining the capability information of the terminal, whether the terminal has the multi-panel beam collaborative management capability. In the case of the terminal having the capability, it may be determined that the terminal is capable of determining the alternate second panel when the first panel is used for communication with the base station, so that the terminal may be indicated to enable the second panel for communication when the quality of communication with the first panel does not satisfy the requirements in the subsequent period, making that the terminal can quickly turn on the second panel without having to determine the suitable panel among all the panels. It is beneficial for the terminal to quickly turn on the suitable panel for communication, reducing communication delay, and saving power consumption.

In an embodiment, the capability information may occupy 1 bit, e.g., 1 indicates that the terminal has the capability and 0 indicates that the terminal does not have the capability.

In an embodiment, the capability information is further used for indicating a panel the multi-panel beam collaborative management capability is applicable to.

A plurality of panels may be provided in the terminal, and the multi-panel beam collaborative management capability that the terminal has may be applicable to all or partial panels, i.e., the terminal is capable of determining the alternate second panel when the first panel is used for communication with the base station, where both the first panel and the second panel belong to the panels that the capability is applicable to.

In this case, the capability information may occupy a plurality of bits, for example, 1 bit still indicates whether the terminal has the capability, and other bits may indicate the panel that the capability is applicable to. For example, there are four panels in the terminal, namely panel 1, panel 2, panel 3, and panel 4, the terminal has the capability, and the capability is applicable to panel 1, panel 2, and panel 4, then the capability information may occupy 5 bits, for example, the capability information may be 11101, with the first bit being 1 to indicate that the terminal has the capability, the second bit, the third bit and the fifth bit being 1 to indicate that the capability is applicable to panel 1, panel 2 and panel 4, and the fourth bit being 0 to indicate that the capability is not applicable to panel 3.

In an embodiment, the capability information is further used for indicating identification information of an alternate panel of a panel currently used for communication. Accordingly, the base station may accurately determine which panels in the terminal may be used as the alternate panels of the panel currently used for communication, and thus subsequently the base station, when sending a second request to the terminal, may explicitly request information of all the alternate panels, or of the partially specified alternate panels, from the terminal by means of the second request.

In an embodiment, the multi-panel beam collaborative management capability refers to the terminal being capable of determining the alternate second panel and an alternate second beam when the first panel is used for the communication with the base station.

The terminal having the capability may refer to that the terminal is capable of not only determining the second panel, but also determining the alternate second beam. Since the terminal may communicate on a plurality of beams when using the second panel, the terminal, after determining the second panel, may further determine, among a plurality of beams that can be used by the second panel, the beam on which the communication quality satisfies the requirements as the second beam, so that when the communication quality of the communication performed through the first panel does not satisfy the requirements, the terminal may enable, based on an indication of the base station (or automatically), the second panel to communicate with the base station on the second beam to ensure the communication quality.

In an embodiment, the method further includes: sending a first request to the terminal before obtaining the capability information of the terminal. The first request is used for requesting to obtain the capability information.

The base station may first send the first request to the terminal when the capability information is needed. The terminal may determine, based on the first request, that the base station needs to obtain the capability information, thereby reporting the capability information to the base station.

FIG. 2 is a schematic flowchart of another method for capability acquisition illustrated according to an embodiment of the present disclosure. As shown in FIG. 2, in some embodiments, the method further includes the following step S201.

At step S201, a second request is sent, in response to the terminal having the multi-panel beam collaborative management capability, to the terminal when the communication with the terminal is performed through the first panel. The second request is used for requesting to obtain information of the second panel.

In an embodiment, in the case of the terminal having the capability, if the panel currently used by the terminal to communicate with the base station is the first panel, then the base station may send the second request to the terminal to request the terminal to report to the base station the information of the alternate second panel of the first panel.

The information of the second panel includes, but is not limited to, at least one of the following: an identification of the second panel (e.g., a number), a communication quality of communication performed by using the second panel after activation of the second panel, an identification of the second beam (e.g., an index), a communication quality of communication performed on the second beam by using the second panel, and the like. The communication quality may be characterized by reference signal receiving power (RSRP), reference signal receiving quality (RSRQ), and the like.

It should be noted that the multi-panel beam collaborative management capability may be applied to a plurality of panels in the terminal, but the alternate second panel, determined when the first panel is used for the communication with the base station, may be only partial panels among the plurality of the panels. For example, the alternate second panel may be the panel, among the plurality of the panels in the terminal, whose predicted communication quality of communication with the base station satisfies the requirements when the first panel is used by the terminal for the communication with the base station.

In an embodiment, the terminal may carry the identification of the second panel and/or the identification of the second beam in the capability information to be reported to the base station, and the information of the second panel may carry the communication quality of the communication performed by using the second panel and/or the communication quality of the communication performed on the second beam by using the second panel. The specific method for reporting to the base station may be set as needed.

After receiving the second request, the terminal may send the information of the second panel to the base station. For example, the terminal may specifically send a second communication quality of the communication performed through the second panel to the base station. The base station may determine, when determining that a first communication quality of the communication performed by the terminal through the first panel does not satisfy the requirements (e.g., less than a first quality threshold), whether the second communication quality satisfies the requirements (e.g., greater than a second quality threshold, the second quality threshold and the first quality threshold may be equal or unequal, e.g., the second quality threshold may be greater than the first quality threshold), and if the second communication quality satisfies the requirements, the base station may indicate the terminal to perform the communication by using the second panel to ensure the communication quality.

In an embodiment, the sending the second request to the terminal in response to the communication with the terminal being performed through the first panel includes: sending the second request to the terminal in response to the communication with the terminal being performed through the first panel and the first communication quality of the communication performed through the first panel being less than the first quality threshold.

The base station may send the second request to the terminal only when the first communication quality of the communication performed by the terminal through the first panel does not satisfy the requirements. The terminal may send the first communication quality to the base station when performing the communication by using the first panel.

Since the second request is used for requesting the information of the second panel, and the base station obtains the information of the second panel generally to determine whether the communication quality of the communication performed by using the second panel satisfies the requirements, in the case that the communication quality of communication performed by using the first panel satisfies the requirements, the base station may not have to consider the communication quality of the other panels, and therefore does not have to send the second request to the terminal. The second request is sent to the terminal only when the communication quality of the communication performed by using the first panel does not satisfy the requirements (e.g., is less than the first quality threshold), so as to reduce unnecessary communication and save communication resources.

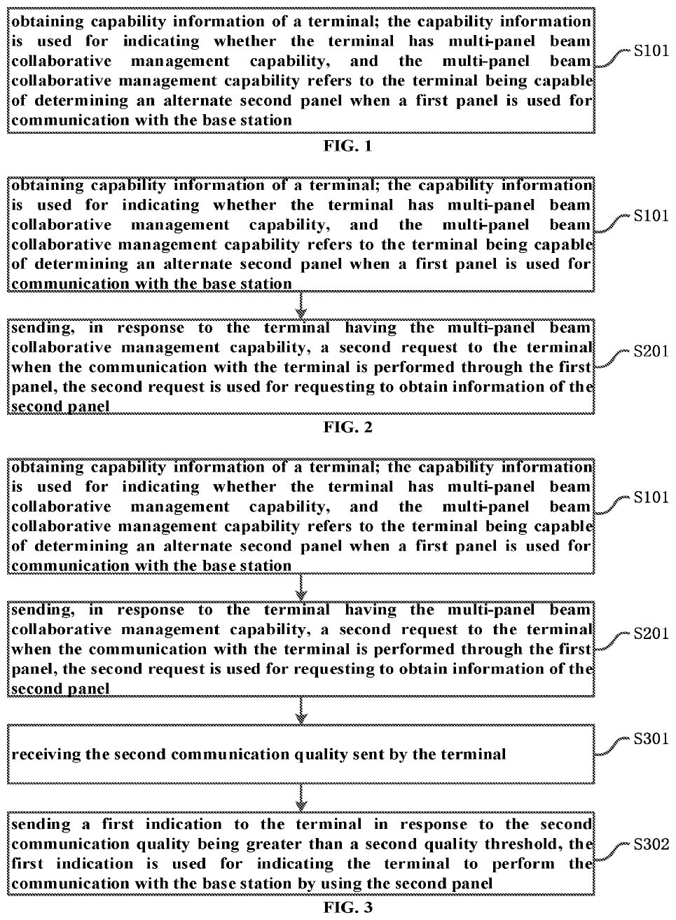

FIG. 3 is a schematic flowchart of yet another method for capability acquisition illustrated according to an embodiment of the present disclosure. As shown in FIG. 3, in some embodiments, the information of the second panel includes the second communication quality of the communication performed by the terminal through the second panel, and the method further includes the following steps S301 to S302.

At step S301, the second communication quality sent by the terminal is received.

At step S302, a first indication is sent to the terminal in response to the second communication quality being greater than the second quality threshold. The first indication is used for indicating the terminal to perform the communication with the base station by using the second panel.

In an embodiment, when the communication quality of the communication performed by using the first panel does not satisfy the requirements, e.g., is less than the first quality threshold, the base station may send, in the case of determining that the second communication quality is greater than the second quality threshold, the first indication to the terminal to indicate the terminal to perform the communication with the base station by using the second panel, thereby ensuring a good communication quality.

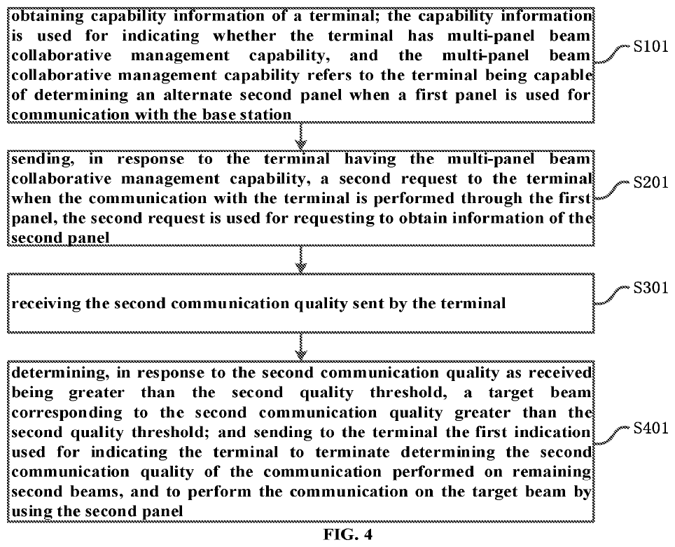

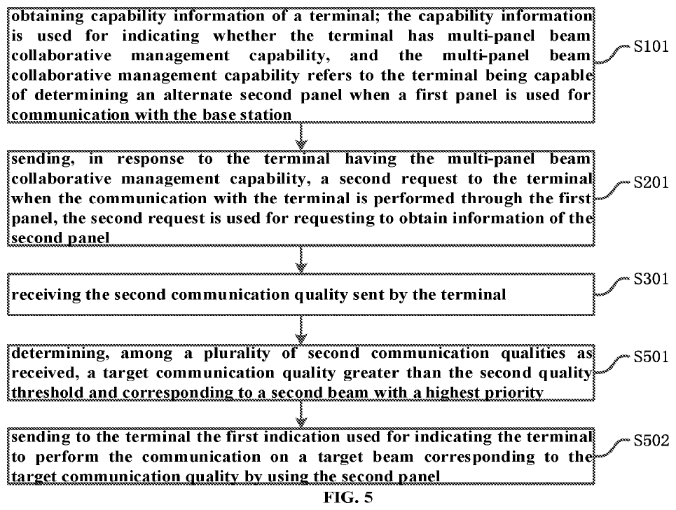

FIG. 4 is a schematic flowchart of yet another method for capability acquisition illustrated according to an embodiment of the present disclosure. As shown in FIG. 4, in some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine based on the priorities, from highest to lowest, the second communication quality of communication performed on each of the second beams, and to send, each time the second communication quality is determined, the second communication quality as determined to the base station.

The sending the first indication to the terminal in response to the second communication quality being greater than the second quality threshold includes the following step S401.

At step S401, a target beam corresponding to the second communication quality greater than the second quality threshold is determined in response to the second communication quality as received being greater than the second quality threshold, and the first indication is sent to the terminal. The first indication is used for indicating the terminal to terminate determining the second communication quality of the communication performed on remaining second beams, and to perform the communication on the target beam by using the second panel.

In an embodiment, if there are a plurality of second beams, each of the second beams may be used as an alternate beam of the alternate second panel when the communication is performed by the terminal through the first panel. In this case, the base station may send the second request to the terminal. Based on the second request, the terminal may determine according to the priorities of the second beams, from highest to lowest, the second communication quality of the communication performed on each of the second beams by using the second panel, and send, each time the second communication quality is determined, the second communication quality as determined to the base station.

Each time the base station receives the second communication quality, the base station may determine whether the second communication quality satisfies the requirements, e.g., whether being greater than the second quality threshold. If the second communication quality as received is greater than the second quality threshold, the target beam corresponding to this second communication quality greater than the second quality threshold may be determined, and the terminal may perform the communication on the target beam by using the second panel, which may satisfy the requirements for the communication quality.

Furthermore, the base station may send the first indication to the terminal. The terminal may terminate, based on the first indication, determining the second communication quality of the communication performed on the remaining second beams to avoid wasting resources resulted in continuing to determine the communication quality, and may perform the communication on the target beam by using the second panel, which may ensure a good communication quality.

FIG. 5 is a schematic flowchart of yet another method for capability acquisition illustrated according to an embodiment of the present disclosure. As shown in FIG. 5, in some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine the second communication quality of communication performed on each of the second beams, and to send the second communication quality of the communication performed on each of the second beams to the base station.

The sending the first indication to the terminal in response to the second communication quality being greater than the second quality threshold includes the following steps S501 to S502.

At step S501, a target communication quality greater than the second quality threshold and corresponding to a second beam with a highest priority is determined among a plurality of second communication qualities as received.

At step S502, the first indication is sent to the terminal. The first indication is used for indicating the terminal to perform the communication on a target beam corresponding to the target communication quality by using the second panel.

In an embodiment, if there are a plurality of second beams, each of the second beams may be used as an alternate beam of the alternate second panel when the communication is performed by the terminal through the first panel. In this case, the base station may send the second request to the terminal. Based on the second request, the terminal may determine the second communication quality of the communication performed on each of the second beams, and send the second communication quality of the communication performed on each of the second beams to the base station. For example, the terminal may detect the second communication quality on each of the second beams respectively after activating the second panel, and send all second communication qualities to the base station after the second communication quality has been detected on all of the second beams by using the second panel.

The base station may determine, after receiving the communication quality of the communication performed by the terminal on each of the second beams by using the second panel, the second communication qualities, among the second communication qualities as received, greater than the second quality threshold, and thus determine the target communication quality, among the second communication qualities greater than the second quality threshold, with the highest priority.

Furthermore, the base station may send the first indication to the terminal. The terminal performs, based on the first indication, the communication on the target beam corresponding to the target communication quality by using the second panel, which may ensure a good communication quality.

In an embodiment, the priorities of the second beams may be set by the terminal as desired; or the terminal may predict, among all the beams that the second panel is able to use, the beams on which the communication quality of communication with the base station satisfies the requirements as the second beams, and then the terminal may predict the communication quality of communication with the base station performed by using each of the second beams, with the higher the predicted communication quality, the higher the priority.

In an embodiment, the manners in which the terminal determines the second panel and the second beam may be set as desired, for example, including, but not limited to, the following three manners.

The first manner: determining the second panel and/or the second beam based on a position of a panel, in the terminal, that the capability is applicable to and a direction of a beam on which a current communication is performed.

The second manner: determining a position of the base station based on a direction of a beam on which a current communication is performed and path loss information of the current communication; and determining the second panel and/or the second beam based on a position of a panel, in the terminal, that the capability is applicable to and the position of the base station.

The third manner: determining a position of the base station based on positioning information; and determining the second panel and/or the second beam based on a position of a panel, in the terminal, that the capability is applicable to and the position of the base station.

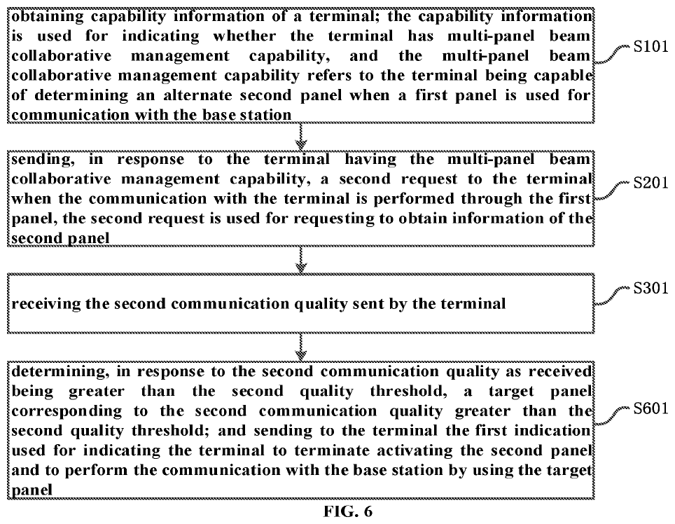

FIG. 6 is a schematic flowchart of yet another method for capability acquisition illustrated according to an embodiment of the present disclosure. As shown in FIG. 6, in some embodiments, the information of the second panel further includes priorities of a plurality of second panels in response to a presence of the plurality of the second panels. The second request is used for requesting the terminal to activate based on the priorities, from highest to lowest, the plurality of the second panels successively, and to send, each time one of the second panels is activated, to the base station the second communication quality of communication performed through the second panel as activated.

The sending the first indication to the terminal in response to the second communication quality being greater than the second quality threshold includes the following step S601.

At step S601, a target panel corresponding to the second communication quality greater than the second quality threshold is determined in response to the second communication quality as received being greater than the second quality threshold, and the first indication is sent to the terminal. The first indication is used for indicating the terminal to terminate activating the second panel and to perform the communication with the base station by using the target panel.

In an embodiment, if there are a plurality of second panels, each of the second panels may be used as an alternate panel of the first panel when the communication is performed by the terminal through the first panel. In this case, the base station may send the second request to the terminal. Based on the second request, the terminal may determine according to the priorities of the second panels, from highest to lowest, the second communication quality of the communication performed by using the second panel, and send, each time the second communication quality is determined, the second communication quality as determined to the base station.

Each time the base station receives the second communication quality, the base station may determine whether the second communication quality satisfies the requirements, e.g., whether being greater than the second quality threshold. If the second communication quality as received is greater than the second quality threshold, the target panel corresponding to this second communication quality greater than the second quality threshold may be determined, and the terminal may perform the communication by using the target panel, which may satisfy the requirements for the communication quality.

Furthermore, the base station may send the first indication to the terminal. The terminal may terminate, based on the first indication, activating the remaining second panels to avoid wasting resources resulted in continuing to determine the communication quality, and may perform the communication by using the target panel, which may ensure a good communication quality.

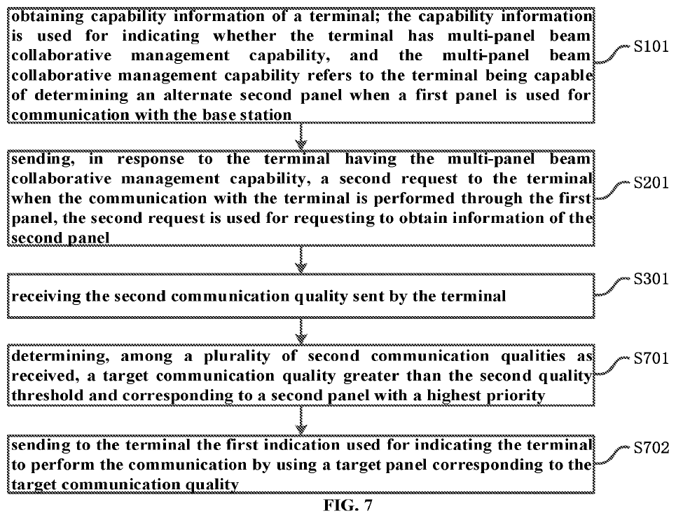

FIG. 7 is a schematic flowchart of yet another method for capability acquisition illustrated according to an embodiment of the present disclosure. As shown in FIG. 7, in some embodiments, the information of the second panel further includes priorities of a plurality of second panels in response to a presence of the plurality of the second panels. The second request is used for requesting the terminal to activate each of the second panels respectively, and to send to the base station the second communication quality of communication performed through each of the second panels as activated.

The sending the first indication to the terminal in response to the second communication quality being greater than the second quality threshold includes the following steps S701 to S702.

At step S701, a target communication quality greater than the second quality threshold and corresponding to a second panel with a highest priority is determined among a plurality of second communication qualities as received.

At step S702, the first indication is sent to the terminal. The first indication is used for indicating the terminal to perform the communication by using a target panel corresponding to the target communication quality.

In an embodiment, if there are a plurality of second panels, each of the second panels may be used as an alternate panel of the first panel when the communication is performed by the terminal through the first panel. In this case, the base station may send the second request to the terminal. Based on the second request, the terminal may determine the second communication quality of the communication performed through each of the second panels, and send to the base station the second communication quality of the communication performed through each of the second panels. For example, the terminal may respectively activate each of the second panels and detect the second communication quality, and send all second communication qualities to the base station after the second communication quality of the communication performed by using each of the second panels has been determined.

The base station may determine, after receiving the communication quality of the communication performed by the terminal through the second panel, the second communication qualities, among the second communication qualities as received, greater than the second quality threshold, and thus determine the target communication quality, among the second communication qualities greater than the second quality threshold, with the highest priority.

Furthermore, the base station may send the first indication to the terminal. The terminal performs, based on the first indication, the communication by using the target panel corresponding to the target communication quality, which may ensure a good communication quality.

In an embodiment, the priorities of the second panels may be set by the terminal as desired; or the terminal may predict, among panels other than the first panel, the panels through which the communication quality of communication with the base station satisfies the requirements as the second panels, and then the terminal may predict the communication quality of communication with the base station performed by using each of the second panels, with the higher the predicted communication quality, the higher the priority.

In an embodiment, indicating through the first indication the terminal to perform the communication by using the second panel includes but is not limited to the following two cases.

The first case: the first indication is used for indicating the terminal to switch from performing the communication by using the first panel to performing the communication by using the second panel. That is, the first indication is used for indicating the terminal to switch panels. The terminal may terminate, based on the first indication, performing the communication with the base station by using the first panel (e.g., turning off the first panel or using the first panel for other functions), and perform the communication with the base station by using the second panel.

The second case: the first indication is used for indicating the terminal to perform the communication by using the first panel and the second panel. That is, the first indication is used for indicating the terminal to perform the communication with the base station by using the second panel, whereas it may be up to the terminal to decide, as desired, whether the first panel is to be used or not. For example, the terminal may perform the communication with the base station by using both the first panel and the second panel.

In an embodiment, the sending the first indication to the terminal in response to the second communication quality being greater than the second quality threshold includes: sending the first indication to the terminal in response to the second communication quality being greater than the second quality threshold and a data volume of data to be transmitted by the terminal being greater than a data volume threshold.

In addition to considering whether the second communication quality is greater than the second quality threshold, the sending the first indication by the base station to the terminal may also consider the data volume of the data to be transmitted by the terminal. If the data volume of the data to be transmitted by the terminal is less, for example, less than the data volume threshold, in such a case, although the communication quality of the communication performed by using the first panel to complete the data to be transmitted may be less than optimal, since the data to be transmitted is less, it will not have too much effect on the overall communication quality; if the first indication is sent to the terminal to cause the terminal to perform the communication with the base station by using the second panel, the consumption of communication resources will be more than worthwhile, so it is not necessary to send the first indication to the terminal. The first indication is sent to the terminal only when the data volume of data to be transmitted is greater, for example, greater than the data volume threshold.

FIG. 8 is a schematic flowchart of a method for capability reporting illustrated according to an embodiment of the present disclosure. The method for capability reporting shown in this embodiment may be applied to a terminal. The terminal includes but is not limited to a communication device such as a cellular phone, a tablet computer, a wearable device, a sensor, an IOT device, and the like. The terminal may be used as a user device and communicate with a base station. The base station includes but is not limited to a base station in a communication system such as a 4G base station, a 5G base station, a 6G base station, and the like.

In an embodiment, the base station may be a base station that the method for capability acquisition described in any above embodiment is applicable to.

In an embodiment, a plurality of panels may be provided in the terminal, and different panels may be provided at different positions in the terminal. The panel refers to the antenna panel in the terminal, and the terminal may perform communication by using the antenna panel. The panel may communicate on a plurality of beams, and directions of each of the beams may be different.

The following is mainly described in the case of the plurality of panels including the first panel and the second panel. The first panel and the second panel do not specifically refer to particular panels in the terminal, but mainly refers to any two different panels in the terminal.

As shown in FIG. 8, the method for capability reporting may include the following step S801.

At step S801, capability information is sent to the base station. In this embodiment, the capability information is used for indicating whether the terminal has multi-panel beam collaborative management capability, and the multi-panel beam collaborative management capability refers to the terminal being capable of determining an alternate second panel when a first panel is used for communication with the base station.

In an embodiment, the terminal may report the capability information, for example, the terminal may directly report the capability information to the base station, or the terminal may report the capability information to a core network, which then sends the capability information to the base station. For example, the terminal may report the capability information to the base station by carrying the capability information in a newly added signaling, or the terminal may report the capability information to the base station by expanding an existing signaling to carry the capability information, such as reporting the capability information to the base station by carrying the capability information in a codebookParameters signaling.

In an embodiment, if the terminal is capable of determining the alternate second panel when the first panel is used for communication with the base station, the terminal may be shown to have the multi-panel beam collaborative management capability through the capability information.

In an embodiment, in the case of the terminal having the capability, when the terminal communicates with the base station by using the first panel, the terminal is able to predict, among the panels other than the first panel, the panel through which the communication quality of communication with the base station satisfies the requirements as the second panel, so that when the communication quality of communication performed by using the first panel does not satisfy the requirements, the terminal may enable, based on an indication of the base station (or automatically), the second panel to communicate with the base station to ensure the communication quality.

According to the embodiments of the present disclosure, the base station may determine, by obtaining the capability information of the terminal, whether the terminal has the multi-panel beam collaborative management capability. In the case of the terminal having the capability, it may be determined that the terminal is capable of determining the alternate second panel when the first panel is used for communication with the base station, so that the terminal may be indicated to enable the second panel for communication when the quality of communication with the first panel does not satisfy the requirements in the subsequent period, making that the terminal can quickly turn on the second panel without having to determine the suitable panel among all the panels. It is beneficial for the terminal to quickly turn on the suitable panel for communication, reducing communication delay, and saving power consumption.

In an embodiment, the capability information may occupy 1 bit, e.g., 1 indicates that the terminal has the capability and 0 indicates that the terminal does not have the capability.

In an embodiment, the capability information is further used for indicating a panel the multi-panel beam collaborative management capability is applicable to.

A plurality of panels may be provided in the terminal, and the multi-panel beam collaborative management capability that the terminal has may be applicable to all or partial panels, i.e., the terminal is capable of determining the alternate second panel when the first panel is used for communication with the base station, where both the first panel and the second panel belong to the panels that the capability is applicable to.

In this case, the capability information may occupy a plurality of bits, for example, 1 bit still indicates whether the terminal has the capability, and other bits may indicate the panel that the capability is applicable to. For example, there are four panels in the terminal, namely panel 1, panel 2, panel 3, and panel 4, the terminal has the capability, and the capability is applicable to panel 1, panel 2, and panel 4, then the capability information may occupy 5 bits, for example, the capability information may be 11101, with the first bit being 1 to indicate that the terminal has the capability, the second bit, the third bit and the fifth bit being 1 to indicate that the capability is applicable to panel 1, panel 2 and panel 4, and the fourth bit being 0 to indicate that the capability is not applicable to panel 3.

In an embodiment, the capability information is further used for indicating identification information of an alternate panel of a panel currently used for communication. Accordingly, the base station may accurately determine which panels in the terminal may be used as the alternate panels of the panel currently used for communication, and thus subsequently the base station, when sending a second request to the terminal, may explicitly request information of all the alternate panels, or of partially specified alternate panels, from the terminal by means of the second request.

In an embodiment, the multi-panel beam collaborative management capability refers to the terminal being capable of determining the alternate second panel and an alternate second beam when the first panel is used for the communication with the base station.

The terminal having the capability may refer to that the terminal is capable of not only determining the second panel, but also determining the alternate second beam. Since the terminal may communicate on a plurality of beams when using the second panel, the terminal, after determining the second panel, may further determine, among a plurality of beams that can be used by the second panel, the beam on which the communication quality satisfies the requirements as the second beam, so that when the communication quality of the communication performed through the first panel does not satisfy the requirements, the terminal may enable, based on an indication of the base station (or automatically), the second panel to communicate with the base station on the second beam to ensure the communication quality.

In an embodiment, the sending the capability information to the base station includes: sending the capability information to the base station in response to receiving a first request sent by the base station. The first request is used for requesting to obtain the capability information.

The base station may first send the first request to the terminal when the capability information is needed. The terminal may determine, based on the first request, that the base station needs to obtain the capability information, thereby reporting the capability information to the base station.

FIG. 9 is a schematic flowchart of another method for capability reporting illustrated according to an embodiment of the present disclosure. As shown in FIG. 9, in some embodiments, the method further includes the following step S901.

At step S901, information of the second panel is sent to the base station in response to receiving a second request sent by the base station when the communication is performed through the first panel. The second request is used for requesting to obtain the information of the second panel.

In an embodiment, in the case of the terminal having the capability, if the panel currently used by the terminal to communicate with the base station is the first panel, then the base station may send the second request to the terminal to request the terminal to report to the base station the information of the alternate second panel of the first panel.

The information of the second panel includes, but is not limited to, at least one of the following: an identification of the second panel (e.g., a number), a communication quality of communication performed by using the second panel after activation of the second panel, an identification of the second beam (e.g., an index), a communication quality of communication performed on the second beam by using the second panel, and the like. The communication quality may be characterized by RSRP, RSRQ, and the like.

After receiving the second request, the terminal may send the information of the second panel to the base station. For example, the terminal may specifically send a second communication quality of the communication performed through the second panel to the base station. The base station may determine, when determining that a first communication quality of the communication performed by the terminal through the first panel does not satisfy the requirements (e.g., less than a first quality threshold), whether the second communication quality satisfies the requirements (e.g., greater than a second quality threshold, the second quality threshold and the first quality threshold may be equal or unequal, e.g., the second quality threshold may be greater than the first quality threshold), and if the second communication quality satisfies the requirements, the base station may indicate the terminal to perform the communication by using the second panel to ensure the communication quality.

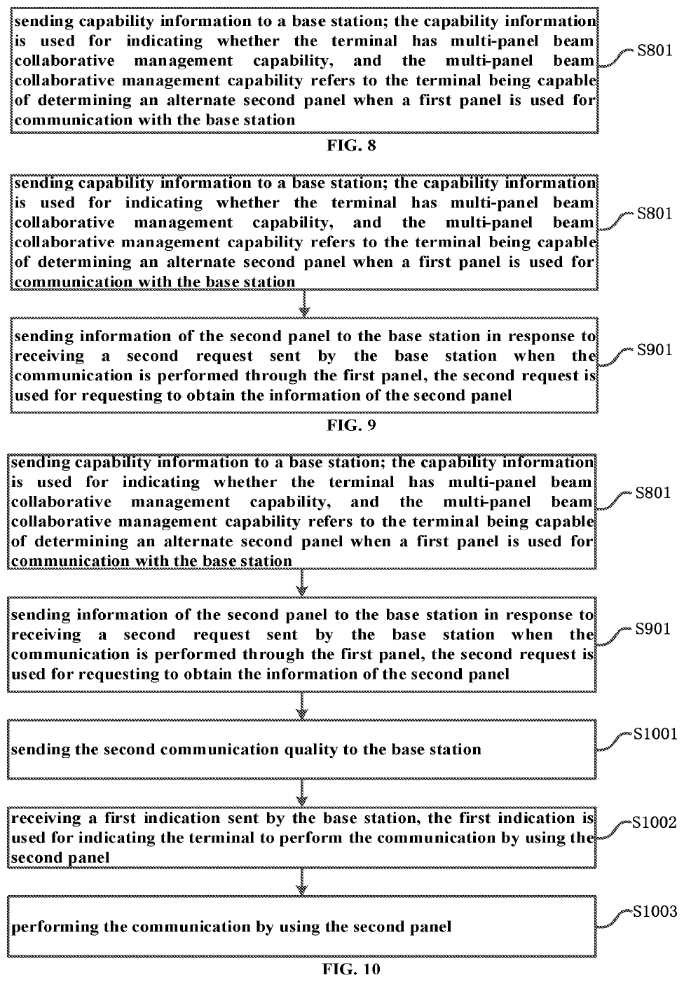

FIG. 10 is a schematic flowchart of another method for capability reporting illustrated according to an embodiment of the present disclosure. As shown in FIG. 10, in some embodiments, the second request is used for requesting the terminal to activate the second panel and to send to the base station the second communication quality of the communication performed through the second panel, and the method further includes the following steps S1001 to S1002.

At step S1001, the second communication quality is sent to the base station.

At step S1002, a first indication sent by the base station is received. The first indication is used for indicating the terminal to perform the communication by using the second panel.

At step S1003, the communication is performed by using the second panel.

In an embodiment, the terminal may send the second communication quality to the base station after receiving the second request. After receiving the second communication quality, the base station may send, in the case that the second communication quality satisfies the requirements (e.g., greater than the second quality threshold) and the first communication quality used by the terminal does not satisfy the requirements (e.g., less than the first quality threshold), the first indication to the terminal to indicate the terminal to perform the communication with the base station by using the second panel, thereby ensuring a good communication quality.

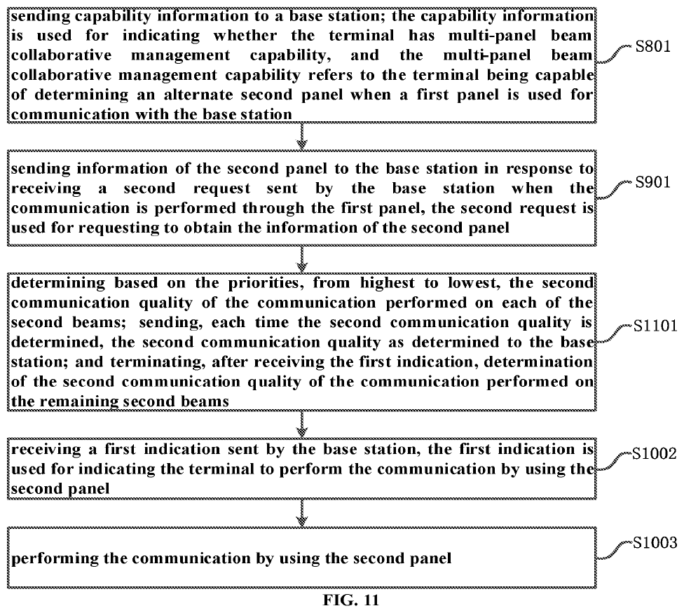

FIG. 11 is a schematic flowchart of yet another method for capability reporting illustrated according to an embodiment of the present disclosure. As shown in FIG. 11, in some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine based on the priorities, from highest to lowest, the second communication quality of communication performed on each of the second beams, and to send, each time the second communication quality is determined, the second communication quality as determined to the base station. The first indication is used for indicating the terminal to terminate determining the second communication quality of the communication performed on remaining second beams, and to perform the communication on a target beam by using the second panel. The target beam is a beam corresponding to the second communication quality being greater than the second quality threshold in second communication qualities received by the base station.

The sending the second communication quality to the base station includes the following step S1101.

At step S1101, the second communication quality of the communication performed on each of the second beams is determined based on the priorities, from highest to lowest, the second communication quality as determined is sent to the base station each time the second communication quality is determined, and determination of the second communication quality of the communication performed on remaining second beams is terminated after the first indication is received.

In an embodiment, if there are a plurality of second beams, it is indicated that the communication quality of the communication performed by the terminal on each of the second beams by using the second panel is good. In this case, the base station may send the second request to the terminal. Based on the second request, the terminal may determine according to the priorities of the second beams, from highest to lowest, the second communication quality of the communication performed on each of the second beams by using the second panel, and send, each time the second communication quality is determined, the second communication quality as determined to the base station.

Each time the base station receives the second communication quality, the base station may determine whether the second communication quality satisfies the requirements, e.g., whether being greater than the second quality threshold. If the second communication quality as received is greater than the second quality threshold, the target beam corresponding to this second communication quality greater than the second quality threshold may be determined, and the terminal may perform the communication on the target beam by using the second panel, which may satisfy the requirements for the communication quality.

Furthermore, the base station may send the first indication to the terminal. The terminal may terminate, based on the first indication, determining the second communication quality of the communication performed on the remaining second beams to avoid wasting resources resulted in continuing to determine the communication quality, and may perform the communication on the target beam by using the second panel, which may ensure a good communication quality.

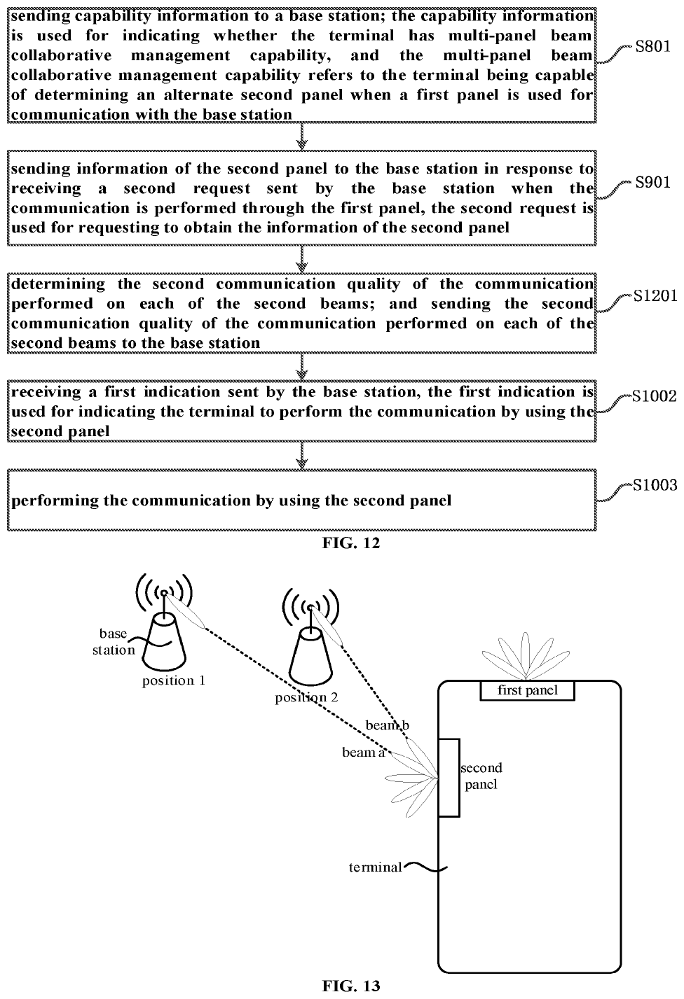

FIG. 12 is a schematic flowchart of yet another method for capability reporting illustrated according to an embodiment of the present disclosure. As shown in FIG. 12, in some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine the second communication quality of communication performed on each of the second beams, and to send the second communication quality of the communication performed on each of the second beams to the base station. The first indication is used for indicating the terminal to perform the communication on a target beam corresponding to a target communication quality by using the second panel, and the target communication quality is determined, among a plurality of second communication qualities received by the base station, to be a communication quality greater than the second quality threshold and corresponding to a second beam with a highest priority.

The sending the second communication quality to the base station includes the following step S1201.

At step S1201, the second communication quality of the communication performed on each of the second beams is determined, and the second communication quality of the communication performed on each of the second beams is sent to the base station.

In an embodiment, if there are a plurality of second beams, each of the second beams may be used as an alternate beam of the alternate second panel when the communication is performed by the terminal through the first panel. In this case, the base station may send the second request to the terminal. Based on the second request, the terminal may determine the second communication quality of the communication performed on each of the second beams, and send the second communication quality of the communication performed on each of the second beams to the base station. For example, the terminal may detect the second communication quality on each of the second beams respectively after activating the second panel, and send all second communication qualities to the base station after the second communication quality has been detected on all of the second beams by using the second panel.

The base station may determine, after receiving the communication quality of the communication performed by the terminal on each of the second beams by using the second panel, the second communication qualities, among the second communication qualities as received, greater than the second quality threshold, and thus determine the target communication quality, among the second communication qualities greater than the second quality threshold, with the highest priority.

Furthermore, the base station may send the first indication to the terminal. The terminal performs, based on the first indication, the communication on the target beam corresponding to the target communication quality by using the second panel, which may ensure a good communication quality.

In an embodiment, the priorities of the second beams may be set by the terminal as desired; or the terminal may predict, among all the beams that the second panel is able to use, the beams on which the communication quality of communication with the base station satisfies the requirements as the second beams, and then the terminal may predict the communication quality of communication with the base station performed by using each of the second beams, with the higher the predicted communication quality, the higher the priority.

In an embodiment, the manners in which the terminal determines the second panel and the second beam may be set as desired, for example, including, but not limited to, the following three manners.

The first manner: determining the second panel and/or the second beam based on a position of a panel, in the terminal, that the capability is applicable to and a direction of a beam (e.g., the beam sent by the base station) on which a current communication is performed.

In an embodiment, the terminal may determine, among the panels, in the terminal, that the capability is applicable to, the alternate second panel when the first panel is used for the communication with the base station, and may further determine the second beam on which the communication is performed by using the second panel.

For example, the panels, in the terminal, that the capability is applicable to include panel A, the direction of the beam on which the current communication is performed is pointing between the first panel and panel A, and the distance between panel A and the first panel is sufficiently close (e.g., less than a distance threshold), then in general, there will be a difference between the communication quality of the communication with the base station performed by using panel A and the communication quality of the communication with the base station performed by using the first panel, but the difference will not be too large. The communication quality of the communication between the base station and the first panel is generally gradual rather than abrupt. Therefore, when the communication quality of the communication with the base station performed by using the first panel does not satisfy the requirements, the communication quality of the communication with the base station performed by using panel A may satisfy the requirements because the difference between the communication quality of the communication with the base station performed by using panel A and the communication quality of the communication with the base station performed by using the first panel is not too large, so that panel A may be determined as the second panel.

After the second panel is determined, the second beam may be further determined. For example, a beam with a smaller angle (e.g., less than the angle threshold) to the beam on which the current communication is performed may be determined, among the beams that the second panel is able to use, as the second beam.

The second manner: determining a position of the base station based on a direction of a beam (e.g., the beam sent by the base station) on which a current communication is performed and path loss information of the current communication; and determining the second panel and/or the second beam based on a position of a panel, in the terminal, that the capability is applicable to and the position of the base station.

The third manner: determining a position of the base station based on positioning information; and determining the second panel and/or the second beam based on a position of a panel, in the terminal, that the capability is applicable to and the position of the base station.

The overall logic of the second manner and the overall logic of the third manner are similar in that they both first determine the position of the base station and then determine the second panel and/or the second beam based on the position of the panel that the capability is applicable to and the position of the base station. The difference is mainly in the way the position of the base station is determined.

The second manner may first determine the path loss information of the current communication. The larger the path loss information is, the farther the distance between the base station and the first panel is. The smaller the path loss information is, the closer the distance between the base station and the first panel is. The distance between the base station and the first panel may be determined based on the path loss information. Further, the angle of the base station relative to the first panel may be determined based on the direction of the beam on which the current communication is performed. Further, the position of the base station may be determined, based on the obtained distance and angle, in polar coordinates.

The third manner determines the position of the base station directly based on the positioning information. The positioning information may be the position of the terminal determined by the terminal based on the positioning system. Based on the position, the position of the base station may be obtained by inverse deduction. Alternatively, the positioning information may be the position of the base station determined by the base station based on the positioning system, then the base station may send the determined position to the terminal.

After the position of the base station is determined, the second panel, the second beam, and the like may be determined based on the position of the panel that the capability is applicable to and the position of the base station.

For example, the panels, in the terminal, that the capability is applicable to include panel B. Based on the position of the base station, the position of the first panel and the position of panel B, the angle between the connection from the base station to the first panel and the connection from the base station to panel B may be determined. If the angle satisfies the requirements (e.g., less than the angle threshold), and the distance between panel B and the first panel is close enough (e.g., less than the distance threshold), then in general, there will be a difference between the communication quality of the communication with the base station performed by using panel B and the communication quality of the communication with the base station performed by using the first panel, but the difference will not be too large. The communication quality of the communication between the base station and the first panel is generally gradual rather than abrupt. Therefore, when the communication quality of the communication with the base station performed by using the first panel does not satisfy the requirements, the communication quality of the communication with the base station performed by using panel B may satisfy the requirements because the difference between the communication quality of the communication with the base station performed by using panel B and the communication quality of the communication with the base station performed by using the first panel is not too large, so that panel B may be determined as the second panel.

After the second panel is determined, the second beam may be further determined. For example, a beam with a smaller angle (e.g., less than the angle threshold) to the beam on which the current communication is performed may be determined, among the beams that the second panel is able to use, as the second beam.

FIG. 13 is a schematic diagram of determining a second beam illustrated according to an embodiment of the present disclosure.

As shown in FIG. 13, for example, the terminal has the multi-panel beam collaborative management capability, and the multi-panel beam collaborative management capability refers to the terminal being capable of determining the alternate second panel and an alternate second beam when the first panel is used for the communication with the base station.

For example, the determined second panel is located on the left side frame of the terminal as shown in FIG. 13. If the determined position of the base station is position 1, and the angle between the beam used for communication between the base station and the first panel of the terminal and the beam a of the second panel is less than the angle threshold, then beam a may be determined as the second beam. If the determined position of the base station is position 2, and the angle between the beam used for communication between the base station and the first panel of the terminal and the beam b of the second panel is less than the angle threshold, then beam b may be determined as the second beam.

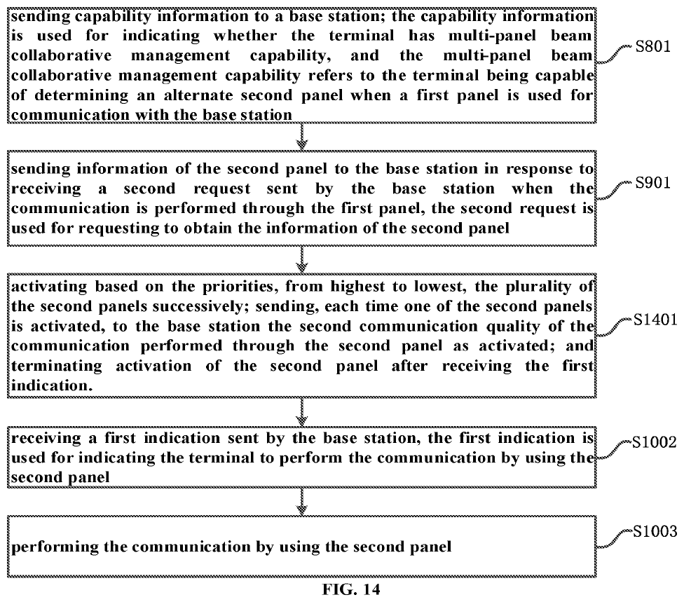

FIG. 14 is a schematic flowchart of yet another method for capability reporting illustrated according to an embodiment of the present disclosure. As shown in FIG. 14, in some embodiments, the information of the second panel further includes priorities of a plurality of second panels in response to a presence of the plurality of the second panels. The second request is used for requesting the terminal to activate based on the priorities, from highest to lowest, the plurality of the second panels successively, and to send, each time one of the second panels is activated, to the base station the second communication quality of communication performed through the second panel as activated. The first indication is used for indicating the terminal to terminate activating the second panel and to perform the communication with the base station by using a target panel.

The sending the second communication quality to the base station includes the following step S1401.

At step S1401, the plurality of the second panels are activated successively based on the priorities, from highest to lowest, the second communication quality of the communication performed through the second panel as activated is sent to the base station each time one of the second panels is activated, and activation of the second panel is terminated after the first indication is received.

In an embodiment, if there are a plurality of second panels, each of the second panels may be used as an alternate panel of the first panel when the communication is performed by the terminal through the first panel. In this case, the base station may send the second request to the terminal. Based on the second request, the terminal may determine according to the priorities of the second panels, from highest to lowest, the second communication quality of the communication performed by using the second panel, and send, each time the second communication quality is determined, the second communication quality as determined to the base station.

Each time the base station receives the second communication quality, the base station may determine whether the second communication quality satisfies the requirements, e.g., whether being greater than the second quality threshold. If the second communication quality as received is greater than the second quality threshold, the target panel corresponding to this second communication quality greater than the second quality threshold may be determined, and the terminal may perform the communication by using the target panel, which may satisfy the requirements for the communication quality.

Furthermore, the base station may send the first indication to the terminal. The terminal may terminate, based on the first indication, activating the remaining second panels to avoid wasting resources resulted in continuing to determine the communication quality, and may perform the communication by using the target panel, which may ensure a good communication quality.

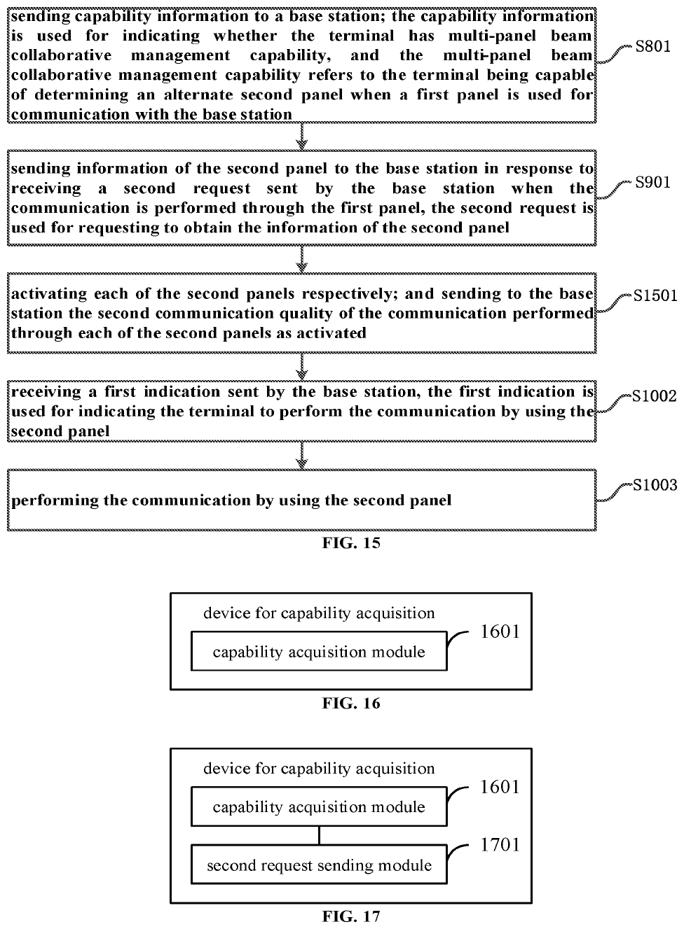

FIG. 15 is a schematic flow diagram of yet another method for capability reporting illustrated according to an embodiment of the present disclosure. As shown in FIG. 15, in some embodiments, the information of the second panel further includes priorities of a plurality of second panels in response to a presence of the plurality of the second panels. The second request is used for requesting the terminal to activate each of the second panels respectively, and to send to the base station the second communication quality of communication performed through each of the second panels as activated. The first indication is used for indicating the terminal to perform the communication by using a target panel corresponding to a target communication quality, and the target communication quality is determined, among a plurality of second communication qualities received by the base station, to be a communication quality greater than the second quality threshold and corresponding to a second panel with a highest priority.

The sending the second communication quality to the base station includes the following step S1501.

At step S1501, each of the second panels is activated respectively, and the second communication quality of the communication performed through each of the second panels as activated is sent to the base station.

In an embodiment, if there are a plurality of second panels, each of the second panels may be used as an alternate panel of the first panel when the communication is performed by the terminal through the first panel. In this case, the base station may send the second request to the terminal. Based on the second request, the terminal may determine the second communication quality of the communication performed through each of the second panels, and send to the base station the second communication quality of the communication performed through each of the second panels. For example, the terminal may respectively activate each of the second panels and detect the second communication quality, and send all second communication qualities to the base station after the second communication quality of the communication performed by using each of the second panels has been determined.

The base station may determine, after receiving the communication quality of the communication performed by the terminal through the second panel, the second communication qualities, among the second communication qualities as received, greater than the second quality threshold, and thus determine the target communication quality, among the second communication qualities greater than the second quality threshold, with the highest priority.

Furthermore, the base station may send the first indication to the terminal. The terminal performs, based on the first indication, the communication by using the target panel corresponding to the target communication quality, which may ensure a good communication quality.

In an embodiment, the priorities of the second panels may be set by the terminal as desired; or the terminal may predict, among panels other than the first panel, the panels through which the communication quality of communication with the base station satisfies the requirements as the second panels, and then the terminal may predict the communication quality of communication with the base station performed by using each of the second panels, with the higher the predicted communication quality, the higher the priority.

In an embodiment, indicating through the first indication the terminal to perform the communication by using the second panel includes but is not limited to the following two cases: the first indication is used for indicating the terminal to switch from performing the communication by using the first panel to performing the communication by using the second panel; and the first indication is used for indicating the terminal to perform the communication by using the first panel and the second panel. For these two cases, the actions performed by the terminal are also different.

In an embodiment, in response to the first indication being used for indicating the terminal to switch from performing the communication by using the first panel to performing the communication by using the second panel, the performing the communication by using the second panel includes: switching from performing the communication by using the first panel to performing the communication by using the second panel.

That is, the first indication is used for indicating the terminal to switch panels. The terminal may terminate, based on the first indication, performing the communication with the base station by using the first panel (e.g., turning off the first panel or using the first panel for other functions), and perform the communication with the base station by using the second panel.

In an embodiment, in response to the first indication being used for indicating the terminal to perform the communication by using the first panel and the second panel, the performing the communication by using the second panel includes: performing the communication by using the first panel and the second panel.

That is, the first indication is used for indicating the terminal to perform the communication with the base station by using the second panel, whereas it may be up to the terminal to decide, as desired, whether the first panel is to be used or not. For example, the terminal may perform the communication with the base station by using both the first panel and the second panel.

Corresponding to the foregoing embodiments of the method for capability acquisition and the method for capability reporting, the present disclosure also provides embodiments of a device for capability acquisition and device for capability reporting.

FIG. 16 is a schematic block diagram of a device for capability acquisition illustrated according to an embodiment of the present disclosure. The device for capability acquisition shown in this embodiment is applied to a base station. The base station includes but is not limited to a base station in a communication system such as a 4G base station, a 5G base station, a 6G base station, and the like. The base station may communicate with a terminal which is used as a user device. The terminal includes but is not limited to a communication device such as a cellular phone, a tablet computer, a wearable device, a sensor, an IOT device, and the like.

As shown in FIG. 16, the device for capability acquisition may include a capability acquisition module 1601.

The capability acquisition module 1601 is configured to obtain capability information of a terminal.

The capability information is used for indicating whether the terminal has multi-panel beam collaborative management capability, and the multi-panel beam collaborative management capability refers to the terminal being capable of determining an alternate second panel when a first panel is used for communication with the base station.

In an embodiment, the capability information is further used for indicating a panel the multi-panel beam collaborative management capability is applicable to.

In an embodiment, the capability information is further used for indicating identification information of an alternate panel of a panel currently used for communication.

In an embodiment, the multi-panel beam collaborative management capability refers to the terminal being capable of determining the alternate second panel and an alternate second beam when the first panel is used for the communication with the base station.

In an embodiment, the device further includes a first request sending module, configured to send a first request to the terminal before obtaining the capability information of the terminal. The first request is used for requesting to obtain the capability information.

FIG. 17 is a schematic block diagram of another device for capability acquisition illustrated according to an embodiment of the present disclosure. As shown in FIG. 17, in some embodiments, the device further includes a second request sending module 1701, configured to send, in response to the terminal having the multi-panel beam collaborative management capability, a second request to the terminal when the communication with the terminal is performed through the first panel. The second request is used for requesting to obtain information of the second panel.

In some embodiments, the second request sending module is specifically configured to send the second request to the terminal in response to the communication with the terminal being performed through the first panel and a first communication quality of the communication performed through the first panel being less than a first quality threshold.

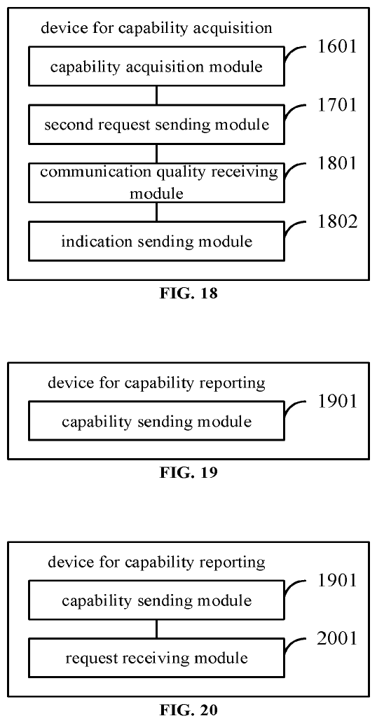

FIG. 18 is a schematic block diagram of yet another device for capability acquisition illustrated according to an embodiment of the present disclosure. As shown in FIG. 18, in some embodiments, the information of the second panel includes a second communication quality of communication performed by the terminal through the second panel. The device further includes a communication quality receiving module 1801 and an indication sending module 1802.

The communication quality receiving module 1801 is configured to receive the second communication quality sent by the terminal.

The indication sending module 1802 is configured to send a first indication to the terminal in response to the second communication quality being greater than a second quality threshold. The first indication is used for indicating the terminal to perform the communication with the base station by using the second panel.

In some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine based on the priorities, from highest to lowest, the second communication quality of communication performed on each of the second beams, and to send, each time the second communication quality is determined, the second communication quality as determined to the base station.

The indication sending module is specifically configured to determine, in response to the second communication quality as received being greater than the second quality threshold, a target beam corresponding to the second communication quality greater than the second quality threshold, and to send to the terminal the first indication. The first indication is used for indicating the terminal to terminate determining the second communication quality of the communication performed on remaining second beams, and to perform the communication on the target beam by using the second panel.

In some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine the second communication quality of communication performed on each of the second beams, and to send the second communication quality of the communication performed on each of the second beams to the base station.

The indication sending module is specifically configured to: determine, among a plurality of second communication qualities as received, a target communication quality greater than the second quality threshold and corresponding to a second beam with a highest priority; and send to the terminal the first indication used for indicating the terminal to perform the communication on a target beam corresponding to the target communication quality by using the second panel.

In some embodiments, the information of the second panel further includes priorities of a plurality of second panels in response to a presence of the plurality of the second panels. The second request is used for requesting the terminal to activate based on the priorities, from highest to lowest, the plurality of the second panels successively, and to send, each time one of the second panels is activated, to the base station the second communication quality of communication performed through the second panel as activated.

The indication sending module is specifically configured to: determine, in response to the second communication quality as received being greater than the second quality threshold, a target panel corresponding to the second communication quality greater than the second quality threshold; and send to the terminal the first indication used for indicating the terminal to terminate activating the second panel and to perform the communication with the base station by using the target panel.

In some embodiments, the information of the second panel further includes priorities of a plurality of second panels in response to a presence of the plurality of the second panels. The second request is used for requesting the terminal to activate each of the second panels respectively, and to send to the base station the second communication quality of communication performed through each of the second panels as activated.

The indication sending module is specifically configured to: determine, among a plurality of second communication qualities as received, a target communication quality greater than the second quality threshold and corresponding to a second panel with a highest priority; and send to the terminal the first indication used for indicating the terminal to perform the communication by using a target panel corresponding to the target communication quality.

In some embodiments, the first indication is used for indicating the terminal to switch from performing the communication by using the first panel to performing the communication by using the second panel.

In some embodiments, the first indication is used for indicating the terminal to perform the communication by using the first panel and the second panel.

In some embodiments, the indication sending module is specifically configured to send the first indication to the terminal in response to the second communication quality being greater than the second quality threshold and a data volume of data to be transmitted by the terminal being greater than a data volume threshold.

FIG. 19 is a schematic block diagram of a device for capability reporting illustrated according to an embodiment of the present disclosure. The device for capability reporting shown in this embodiment may be applied to a terminal. The terminal includes but is not limited to a communication device such as a cellular phone, a tablet computer, a wearable device, a sensor, an IOT device, and the like. The terminal may be used as a user device and communicate with a base station. The base station includes but is not limited to a base station in a communication system such as a 4G base station, a 5G base station, a 6G base station, and the like.

As shown in FIG. 19, the device for capability reporting may include a capability sending module 1901.

The capability sending module 1901 is configured to send capability information to a base station.

The capability information is used for indicating whether the terminal has multi-panel beam collaborative management capability, and the multi-panel beam collaborative management capability refers to the terminal being capable of determining an alternate second panel when a first panel is used for communication with the base station.

In some embodiments, the capability information is further used for indicating a panel the multi-panel beam collaborative management capability is applicable to.

In some embodiments, the capability information is further used for indicating identification information of an alternate panel of a panel currently used for communication.

In some embodiments, the multi-panel beam collaborative management capability refers to the terminal being capable of determining the alternate second panel and an alternate second beam when the first panel is used for the communication with the base station.

In some embodiments, the capability sending module is specifically configured to send the capability information to the base station in response to receiving a first request sent by the base station. The first request is used for requesting to obtain the capability information.

FIG. 20 is a schematic block diagram of another device for capability reporting illustrated according to an embodiment of the present disclosure. As shown in FIG. 20, the device further includes a request receiving module 2001.

The request receiving module 2001 is further configured to send information of the second panel to the base station in response to receiving a second request sent by the base station when the communication is performed through the first panel. The second request is used for requesting to obtain the information of the second panel.

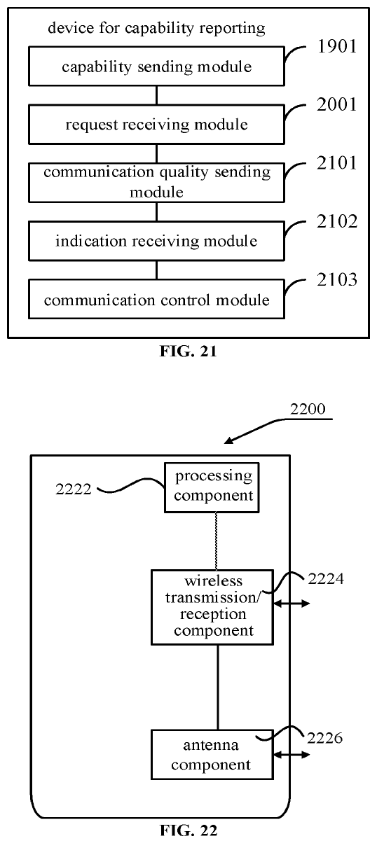

FIG. 21 is a schematic block diagram of yet another device for capability reporting illustrated according to an embodiment of the present disclosure. The second request is used for requesting the terminal to activate the second panel and to send to the base station a second communication quality of communication performed through the second panel. The device further includes a communication quality sending module 2101, an indication receiving module 2102 and a communication control module 2103.

The communication quality sending module 2101 is configured to send the second communication quality to the base station.

The indication receiving module 2102 is configured to receive a first indication sent by the base station. The first indication is used for indicating the terminal to perform the communication by using the second panel.

The communication control module 2103 is configured to perform the communication by using the second panel.

In some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine based on the priorities, from highest to lowest, the second communication quality of communication performed on each of the second beams, and to send, each time the second communication quality is determined, the second communication quality as determined to the base station. The first indication is used for indicating the terminal to terminate determining the second communication quality of the communication performed on remaining second beams, and to perform the communication on a target beam by using the second panel. The target beam is a beam corresponding to the second communication quality being greater than the second quality threshold in second communication qualities received by the base station.

The communication quality sending module is specifically configured to: determine based on the priorities, from highest to lowest, the second communication quality of the communication performed on each of the second beams; send, each time the second communication quality is determined, the second communication quality as determined to the base station; and terminate, after receiving the first indication, determination of the second communication quality of the communication performed on the remaining second beams.

In some embodiments, the multi-panel beam collaborative management capability refers to the terminal being capable of determining the alternate second panel and an alternate second beam when the first panel is used for the communication with the base station.

The information of the second panel further includes priorities of a plurality of second beams in response to a presence of the plurality of the second beams. The second request is used for requesting the terminal to determine the second communication quality of communication performed on each of the second beams, and to send the second communication quality of the communication performed on each of the second beams to the base station. The first indication is used for indicating the terminal to perform the communication on a target beam corresponding to a target communication quality by using the second panel, and the target communication quality is determined, among a plurality of second communication qualities received by the base station, to be a communication quality greater than the second quality threshold and corresponding to a second beam with a highest priority.

The communication quality sending module is specifically configured to: determine the second communication quality of the communication performed on each of the second beams; and send the second communication quality of the communication performed on each of the second beams to the base station.

In some embodiments, the device further includes a first alternate determination module, configured to determine the second panel and/or the second beam based on a position of a panel, in the terminal, that the capability is applicable to and a direction of a beam on which a current communication is performed.

In some embodiments, the device further includes a second alternate determination module, configured to: determine a position of the base station based on a direction of a beam on which a current communication is performed and path loss information of the current communication; and determine the second panel and/or the second beam based on a position of a panel, in the terminal, that the capability is applicable to and the position of the base station.

In some embodiments, the device further includes a second alternate determination module, configured to: determine a position of the base station based on positioning information; and determine the second panel and/or the second beam based on a position of a panel, in the terminal, that the capability is applicable to and the position of the base station.

In some embodiments, the information of the second panel further includes priorities of a plurality of second panels in response to a presence of the plurality of the second panels. The second request is used for requesting the terminal to activate based on the priorities, from highest to lowest, the plurality of the second panels successively, and to send, each time one of the second panels is activated, to the base station the second communication quality of communication performed through the second panel as activated. The first indication is used for indicating the terminal to terminate activating the second panel and to perform the communication with the base station by using a target panel.

The communication quality sending module is specifically configured to: activate based on the priorities, from highest to lowest, the plurality of the second panels successively; send, each time one of the second panels is activated, to the base station the second communication quality of the communication performed through the second panel as activated; and terminate activation of the second panel after receiving the first indication.

In some embodiments, the information of the second panel further includes priorities of a plurality of second panels in response to a presence of the plurality of the second panels. The second request is used for requesting the terminal to activate each of the second panels respectively, and to send to the base station the second communication quality of communication performed through each of the second panels as activated. The first indication is used for indicating the terminal to perform the communication by using a target panel corresponding to a target communication quality, and the target communication quality is determined, among a plurality of second communication qualities received by the base station, to be a communication quality greater than the second quality threshold and corresponding to a second panel with a highest priority.

The communication quality sending module is specifically configured to activate each of the second panels respectively, and send to the base station the second communication quality of the communication performed through each of the second panels as activated.

In some embodiments, in response to the first indication being used for indicating the terminal to switch from performing the communication by using the first panel to performing the communication by using the second panel, the communication quality sending module is specifically configured to switch from performing the communication by using the first panel to performing the communication by using the second panel.

In some embodiments, in response to the first indication being used for indicating the terminal to perform the communication by using the first panel and the second panel, the communication quality sending module is specifically configured to perform the communication by using the first panel and the second panel.

Regarding the devices in the above embodiments, the specific manners in which each module performs operations have been described in detail in the relevant method embodiments, and will not be elaborated here.

For device embodiments, since they basically correspond to method embodiments, please refer to the partial description of method embodiments for relevant information. The device embodiments described above are only schematic, where the modules described as separate components may be or may not be physically separated, and the components displayed as modules may be or may not be physical modules, which may be located in one place or distributed across multiple network modules. Partial or all modules may be selected according to actual needs to achieve the purpose of the embodiments of the present disclosure. Those ordinary skilled in the art may understand and implement the embodiments without making creative labor.

An embodiment of the present disclosure also proposes a communication device. The communication device includes a processor and a memory. The memory is configured to store a computer program. The computer program, when executed by the processor, implements the method for capability acquisition described in any of the above embodiments, and/or the method for capability reporting described in any of the above embodiments.

An embodiment of the present disclosure also proposes a computer-readable storage medium. The computer-readable storage medium is configured to store a computer program. The computer program, when executed by a processor, implements steps of the method for capability acquisition described in any of the above embodiments, and/or steps of the method for capability reporting described in any of the above embodiments.

As shown in FIG. 22, FIG. 22 is a schematic block diagram of a device 2200 for capability acquisition illustrated according to an embodiment of the present disclosure. The device 2200 may be provided as a base station. Referring to FIG. 22, the device 2200 includes a processing component 2222, a wireless transmission/reception component 2224, an antenna component 2226, and a signal processing portion unique to the wireless interface. The processing component 2222 may further include one or more processors. One of the processors in the processing component 2222 may be configured to implement the method for capability acquisition described in any of the above embodiments.

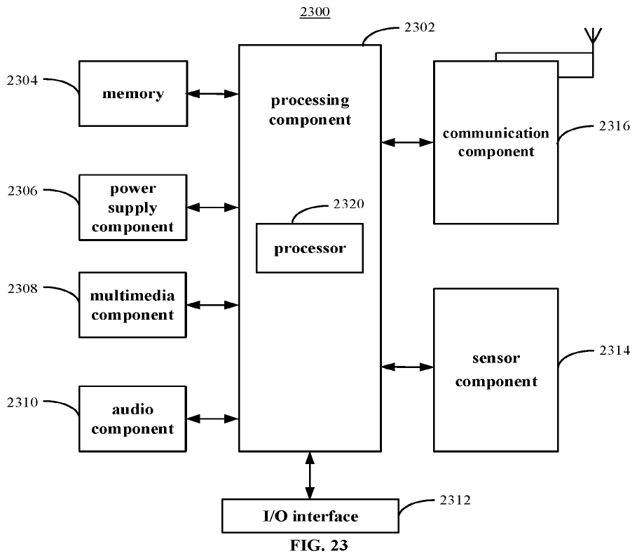

FIG. 23 is a schematic block diagram of device 2300 for capability reporting illustrated according to an embodiment of the present disclosure. For example, the device 2300 may be a cellular phone, a computer, a digital broadcasting terminal, a message transceiver device, a gaming console, a tablet device, a medical device, a fitness device, a personal digital assistant, and the like.

Referring to FIG. 23, the device 2300 may include at least one of the following components: a processing component 2302, a memory 2304, a power supply component 2306, a multimedia component 2308, an audio component 2310, an input/output (I/O) interface 2312, a sensor component 2314, and a communication component 2316.

The processing component 2302 generally controls the overall operation of the device 2300, such as operations associated with display, telephone calls, data communication, camera operations, and recording operations. The processing component 2302 may include one or more processors 2320 to execute an instruction to complete all or some of the steps of the method for capability reporting described above. In addition, the processing component 2302 may include one or more modules that facilitate interaction between the processing component 2302 and other components. For example, the processing component 2302 may include a multimedia module to facilitate interaction between the multimedia component 2308 and the processing component 2302.

The memory 2304 is configured to store various types of data to support the operations at the device 2300. Examples of such data include the following for any application or method to operate on the device 2300: instructions, contact data, phonebook data, messages, pictures, videos, etc. The memory 2304 may be implemented by any type of volatile or non-volatile storage device or a combination thereof, such as a static random access memory (SRAM), electrically erasable programmable read-only memory (EEPROM), erasable programmable read-only memory (EPROM), programmable read-only memory (PROM), read-only memory (ROM), magnetic memory, flash memory, disk or CD-ROM.

The power supply component 2306 supplies power to various components of the device 2300. The power supply component 2306 may include a power supply management system, one or more power supplies, and other components associated with generating, managing, and distributing power for the device 2300.

The multimedia component 2308 includes a screen that provides an output interface between the device 2300 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe action. In some embodiments, the multimedia component 2308 includes a front-facing camera and/or a rear-facing camera. The front-facing camera and/or the rear-facing camera may receive external multimedia data when the device 2300 is in an operating mode, such as a shooting mode or a video mode. Each of the front-facing camera and the rear-facing camera may be a fixed optical lens system or have a focal length and optical zoom capability.

The audio component 2310 is configured to output and/or input audio signals. For example, the audio component 2310 includes a microphone (MIC), configured to receive external audio signals when the device 2300 is in an operating mode, such as a call mode, a recording mode, and a voice recognition mode. The received audio signals may be further stored in the memory 2304 or sent via the communication component 2316. In some embodiments, the audio component 2310 further includes a speaker for outputting the audio signals.

The I/O interface 2312 provides an interface between the processing component 2302 and a peripheral interface module, and the peripheral interface module may be a keypad, a click wheel, a button, etc. These buttons may include, but are not limited to, a home button, a volume button, a start button, and a lock button.

The sensor component 2314 includes one or more sensors, used for providing a status assessment of various aspects of the device 2300. For example, the sensor component 2314 may detect an open/closed state of the device 2300, relative positioning of the components, for example, the components are the display and keypad of the device 2300, the sensor component 2314 may also detect a change in the position of the device 2300 or a change in the position of one component of the device 2300, the presence or absence of user contact with the device 2300, the orientation or acceleration/deceleration of the device 2300, and temperature changes of the device 2300. The sensor component 2314 may include a proximity sensor, configured to detect the presence of nearby objects in the absence of any physical contact. The sensor component 2314 may also include a light sensor, such as a CMOS or CCD image sensor, for use in imaging applications. In some embodiments, the sensor component 2314 may also include an accelerometer sensor, a gyroscope sensor, a magnetic sensor, a pressure sensor, or a temperature sensor.

The communication component 2316 is configured to facilitate the communication between the device 2300 and other devices by wired or wireless means. The device 2300 may access a wireless network based on a communication standard, such as Wi-Fi, 2G, 3G, 4G LTE, 5G NR, or a combination thereof. In an embodiment, the communication component 2316 receives broadcast signals or broadcast-related information from an external broadcast management system via a broadcast channel. In an embodiment, the communication component 2316 further includes a near-field communication (NFC) module to facilitate short-range communication. For example, the NFC module may be implemented based on radio frequency identification (RFID) technology, infrared data association (IrDA) technology, ultra-wideband (UWB) technology, bluetooth (BT) technology, and the like.

In an embodiment, the device 2300 may be implemented by one or more of an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic element, and configured to perform the above method for capability reporting.

In an embodiment, a non-transitory computer-readable storage medium including an instruction is provided, such as a memory 2304 including an instruction. The instruction described above is capable of being executed by the processor 2320 of the device 2300 to complete the above method for capability reporting. For example, the non-transitory computer-readable storage medium may be a ROM, a random access memory (RAM), a CD-ROM, a magnetic tape, a floppy disk, an optical data storage device, etc.

According to the embodiments of the present disclosure, the base station may determine, by obtaining the capability information of the terminal, whether the terminal has the multi-panel beam collaborative management capability. In the case of the terminal having the capability, it may be determined that the terminal is capable of determining the alternate second panel when the first panel is used for communication with the base station, so that the terminal may be indicated to enable the second panel for communication when the quality of communication with the first panel does not satisfy the requirements in the subsequent period, making that the terminal can quickly turn on the second panel without having to determine the suitable panel among all the panels. It is beneficial for the terminal to quickly turn on the suitable panel for communication, reducing communication delay, and saving power consumption.

After considering the specification and practicing the embodiments disclosed herein, those skilled in the art will easily come up with other implementation solutions of the present disclosure. The present disclosure is intended to cover any variations, uses, or adaptive changes of the present disclosure, which follow the general principles of the present disclosure and include common knowledge or commonly used technical means in the technical field that are not disclosed in the present disclosure. The specification and embodiments are only considered illustrative, and the true scope and spirit of the present disclosure are indicated by the following claims.

It is to be understood that the present disclosure is not limited to the precise structure which has been described above and illustrated in the accompanying drawings, and that various modifications and alterations may be made without departing from the scope of the present disclosure. The scope of the present disclosure is limited only by the appended claims.

It should be noted that, in this article, relationship terms such as first and second are used only to distinguish one entity or operation from another, and do not necessarily require or imply the existence of any such actual relationship or order between those entities or operations. The terms “include”, “comprise”, or any other variant thereof, are intended to cover non-exclusive inclusion, so that a process, method, item or device including a set of elements includes not only those elements, but also other elements that are not explicitly listed, or also include elements inherent in such a process, method, item, or device. Without further limitation, the elements limited by the statement “include a . . . ” do not exclude the existence of other identical elements in the process, method, item, or device that includes the elements.

The above provides a detailed introduction to the methods and devices provided in the embodiments of the present disclosure. Specific examples are applied in this article to explain the principles and implementation methods of the present disclosure. The description of the above embodiments is only used to help understand the methods and core ideas of the present disclosure. Meanwhile, for those general skilled in the art, there may be changes in specific implementation methods and application scope based on the ideas of the present disclosure. In summary, the content of this specification should not be understood as a limitation of the present disclosure.

1. A method for capability acquisition, comprising:
obtaining, by a base station, capability information of a terminal; wherein
the capability information is used for indicating whether the terminal has multi-panel beam collaborative management capability, and the multi-panel beam collaborative management capability refers to the terminal being capable of determining an alternate second panel, wherein a first panel is used by the terminal for communication with the base station.

2. The method according to claim 1, wherein the capability information is further used for indicating a panel the multi-panel beam collaborative management capability is applicable to;
the capability information is further used for indicating identification information of an alternate panel of a panel currently used for communication; and
the multi-panel beam collaborative management capability further refers to the terminal being capable of determining an alternate beam.

3-5. (canceled)

6. The method according to claim 1, further comprising:
determining the terminal having the multi-panel beam collaborative management capability; and
sending a second request to the terminal, wherein the communication with the terminal is performed through the first panel, and the second request is used for requesting to obtain information of the second panel.

7. The method according to claim 6, wherein the sending the second request to the terminal comprises:
sending the second request to the terminal, wherein a first communication quality of the communication performed through the first panel is less than a first quality threshold.

8. The method according to claim 7, wherein the information of the second panel comprises a second communication quality of communication performed by the terminal through the second panel, and the method further comprises:
receiving the second communication quality sent by the terminal; and
sending a first indication to the terminal, wherein the second communication quality is greater than a second quality threshold, and the first indication is used for indicating the terminal to perform the communication with the base station by using the second panel.

9. The method according to claim 8, wherein the multi-panel beam collaborative management capability further refers to the terminal being capable of determining a plurality of alternate beams;
the information of the second panel further comprises priorities of the plurality of the alternate beams; and
the second request is used for requesting the terminal to determine based on the priorities, from highest to lowest, the second communication quality of communication performed on each of the alternate beams, and to send, each time the second communication quality is determined for one of the alternate beams, the second communication quality as determined to the base station; and
the sending the first indication to the terminal comprises:
determining, a target beam, corresponding to the second communication quality greater than the second quality threshold, among the alternate beams, wherein the second communication quality as received is greater than the second quality threshold; and
sending to the terminal the first indication used for indicating the terminal to terminate determining the second communication quality of the communication performed on remaining alternate beams, and to perform the communication on the target beam by using the second panel.

10. The method according to claim 8, wherein the multi-panel beam collaborative management capability further refers to the terminal being capable of determining a plurality of alternate beams;
the information of the second panel further comprises priorities of the plurality of the alternate beams; and the second request is used for requesting the terminal to determine the second communication quality of communication performed on each of the alternate beams, and to send the second communication quality of the communication performed on each of the second beams to the base station; and
the sending the first indication to the terminal comprises:
determining, among a plurality of second communication qualities as received, a target communication quality greater than the second quality threshold and corresponding to an alternate beam with a highest priority; and
sending to the terminal the first indication used for indicating the terminal to perform the communication on a target beam, corresponding to the target communication quality, among the alternate beams by using the second panel.

11. The method according to claim 8, wherein the information of the second panel further comprises priorities of a plurality of second panels; and the second request is used for requesting the terminal to activate based on the priorities, from highest to lowest, the plurality of the second panels successively, and to send, each time one of the second panels is activated, to the base station the second communication quality of communication performed through the second panel as activated; and
the sending the first indication to the terminal comprises:
determining a target panel, corresponding to the second communication quality greater than the second quality threshold, among the second panels, wherein the second communication quality as received is greater than the second quality threshold; and
sending to the terminal the first indication used for indicating the terminal to terminate activating remaining second panels and to perform the communication with the base station by using the target panel.

12. The method according to claim 8, wherein the information of the second panel further comprises priorities of a plurality of second panels; and the second request is used for requesting the terminal to activate each of the second panels respectively, and to send to the base station the second communication quality of communication performed through each of the second panels as activated; and
the sending the first indication to the terminal comprises:
determining, among a plurality of second communication qualities as received, a target communication quality greater than the second quality threshold and corresponding to a second panel with a highest priority; and
sending to the terminal the first indication used for indicating the tem to perform the communication by using a target panel, corresponding to the target communication quality, among the second panels.

13-15. (canceled)

16. A method for capability reporting, comprising:
sending, by a terminal, capability information to a base station; wherein
the capability information is used for indicating whether the terminal has multi-panel beam collaborative management capability, and the multi-panel beam collaborative management capability refers to the terminal being capable of determining an alternate second panel, wherein a first panel is used by the terminal for communication with the base station.

17-20. (canceled)

21. The method according to claim 16, further comprising:
sending information of the second panel to the base station, wherein the terminal receives a second request sent by the base station when the communication is performed through the first panel, and the second request is used for requesting to obtain the information of the second panel.

22. The method according to claim 21, wherein the second request is used for requesting the terminal to activate the second panel and to send to the base station a second communication quality of communication performed through the second panel, the sending the information of the second panel to the base station comprises sending the second communication quality to the base station, and the method further comprises:
receiving a first indication sent by the base station, wherein the first indication is used for indicating the terminal to perform the communication by using the second panel; and
performing the communication by using the second panel.

23. The method according to claim 22, wherein the multi-panel beam collaborative management capability further refers to the terminal being capable of determining a plurality of alternate beams;
the information of the second panel further comprises priorities of the plurality of the alternate beams; the second request is used for requesting the terminal to determine based on the priorities, from highest to lowest, the second communication quality of communication performed on each of the alternate beams, and to send, each time the second communication quality is determined for one of the alternate beams, the second communication quality as determined to the base station; the first indication is used for indicating the terminal to terminate determining the second communication quality of the communication performed on remaining alternate beams, and to perform the communication on a target beam among the alternate beams by using the second panel; and the target beam is a beam corresponding to the second communication quality being greater than the second quality threshold in second communication qualities received by the base station; and
the sending the second communication quality to the base station comprises:
determining based on the priorities, from highest to lowest, the second communication quality of the communication performed on each of the alternate beams;
sending, each time the second communication quality is determined for one of the alternate beams, the second communication quality as determined to the base station; and
terminating, after receiving the first indication, determination of the second communication quality of the communication performed on the remaining alternate beams.

24. The method according to claim 22, wherein the multi-panel beam collaborative management capability further refers to the terminal being capable of determining a plurality of alternate beams;
the information of the second panel further comprises priorities of the plurality of the alternate beams; the second request is used for requesting the terminal to determine the second communication quality of communication performed on each of the alternate beams, and to send the second communication quality of the communication performed on each of the alternate beams to the base station; the first indication is used for indicating the terminal to perform the communication on a target beam, corresponding to a target communication quality, among the alternate beams by using the second panel, and the target communication quality is determined, among a plurality of second communication qualities received by the base station, to be a communication quality greater than the second quality threshold and corresponding to an alternate beam with a highest priority; and
the sending the second communication quality to the base station comprises:
determining the second communication quality of the communication performed on each of the alternate beams; and
sending the second communication quality of the communication performed on each of the second beams to the base station.

25. The method according to claim 16, wherein the multi-panel beam collaborative management capability further refers to the terminal being capable of determining an alternate beam, and the method further comprises:
determining at least one of the second panel or the alternate beam based on a position of a panel, in the terminal, that the multi-panel beam collaborative management capability is applicable to and a direction of a beam on which a current communication is performed.

26. The method according to claim 16, wherein the multi-panel beam collaborative management capability further refers to the terminal being capable of determining an alternate beam, and the method further comprises:
determining a position of the base station based on a direction of a beam on which a current communication is performed and path loss information of the current communication; and
determining at least one of the second panel or the alternate beam based on a position of a panel, in the terminal, that the multi-panel beam collaborative management capability is applicable to and the position of the base station.

27. The method according to claim 16, wherein the multi-panel beam collaborative management capability further refers to the terminal being capable of determining an alternate beam, and the method further comprises:
determining a position of the base station based on positioning information; and
determining at least one of the second panel or the alternate beam based on a position of a panel, in the terminal, that the capability is applicable to and the position of the base station.

28. The method according to claim 22, wherein the information of the second panel further comprises priorities of a plurality of second panels; the second request is used for requesting the terminal to activate based on the priorities, from highest to lowest, the plurality of the second panels successively, and to send, each time one of the second panels is activated, to the base station the second communication quality of communication performed through the second panel as activated; and the first indication is used for indicating the terminal to terminate activating remaining second panels and to perform the communication with the base station by using a target panel among the second panels;
the sending the second communication quality to the base station comprises:
activating based on the priorities, from highest to lowest, the plurality of the second panels successively;
sending, each time one of the second panels is activated, to the base station the second communication quality of the communication performed through the second panel as activated; and
terminating activation of the remaining second panels after receiving the first indication.

29. The method according to claim 22, wherein the information of the second panel further comprises priorities of a plurality of second panels; the second request is used for requesting the terminal to activate each of the second panels respectively, and to send to the base station the second communication quality of communication performed through each of the second panels as activated; the first indication is used for indicating the terminal to perform the communication by using a target panel, corresponding to a target communication quality, among the second panels, and the target communication quality is determined, among a plurality of second communication qualities received by the base station, to be a communication quality greater than the second quality threshold and corresponding to a second panel with a highest priority; and
the sending the second communication quality to the base station comprises:
activating each of the second panels respectively; and
sending to the base station the second communication quality of the communication performed through each of the second panels as activated.

30-33. (canceled)

34. A communication device, characterized in comprising:
a processor; and
a memory, configured to store a computer program; wherein
the computer program, when executed by the processor, enables the communication device to implement a method for capability acquisition, wherein the method for capability acquisition comprises: obtaining capability information of a terminal; wherein the capability information is used for indicating whether the terminal has multi-panel beam collaborative management capability, and the multi-panel beam collaborative management capability refers to the terminal being capable of determining an alternate second panel, wherein a first panel is used by the terminal for communication with the base station; or
the computer program, when executed by the processor, enables the communication device to implement a method for capability reporting, wherein the method for capability reporting comprises: sending capability information to a base station: wherein the capability information is used for indicating whether the terminal has multi-panel beam collaborative management capability, and the multi-panel beam collaborative management capability refers to the terminal being capable of determining an alternate second panel, wherein a first panel is used by the terminal for communication with the base station.

35. (canceled)
